(19) United States
(12) Patent Application Publication
(10) Pub. No.: US 2003/0155289 A1
(43) Pub. Date: Aug. 21, 2003

(54) Integrated filtration and media management system

(75) Inventors: Michael J. Barnhart, Buffalo, NY (US); Alan F. Lapoint, Scarborough, ME (US)

Correspondence Address: PATRICK R. SCANLON, PIERCE ATWOOD, ONE MONUMENT SQUARE, PORTLAND, ME, 04101, US

(73) Assignee: Lapoint Industries

(21) Appl. No.: 10/078,744

(22) Filed: Feb. 21, 2002

(51) Int. Cl. B01D 24/00

(52) U.S. Cl. 210/237; 210/282

(57) ABSTRACT

An integrated filtration and media management system includes a vessel and a plurality of mesh bags disposed in the vessel. Each one of the mesh bags is filled with a granular filtration media. A hoist is provided for loading and removing bags from the vessel. In one embodiment, the hoist includes a bearing housing fixedly attached to the side of the vessel, a support member rotationally mounted in the bearing housing, and a winch mounted on the support member. The support member can be rotated to selectively position the winch over the vessel.

### BACKGROUND OF THE INVENTION

This invention relates generally to filtration systems and more particularly to filtration systems having improved handling of filtration media.

In industry, fluids carrying impurities are typically filtered by passing the fluid through a granular filtration media such as activated carbon. The impurities are adsorbed or otherwise collected by the filtration media, thereby removing them from the fluid stream. Various filtration systems for removing impurities from a fluid flow are available for many applications. For example, filtration systems are used to remove particles and bacteria from water to purify the water, thus making it suitable for drinking or other purposes. Filtration systems are also used to cleanse other types of fluids, as well as gases and vapors. In general, such filtration systems include a vessel for containing the filtration media and means for passing the fluid stream through the filtration media.

In the course of cleansing fluid streams, the filtration media will eventually become saturated with impurities and be unable to adsorb further materials. At this point, the filtration media needs to be replaced with fresh media for continued operation of the filtration system. This requires a significant amount of coordination between filtration system operators and media suppliers to manage replacement of the filtration media. There are two principle approaches currently used for management of granular filtration media. Media suppliers provide filtration media either in bulk delivery form (e.g., in large bags or as truckloads with pneumatic conveyance) or in replacement vessels or canisters. The bulk delivery approach involves manual handling of the media that results in considerable costs for labor and specialized equipment needed to perform the operation. Consequently, most operators of small to mid-sized filtration systems use the replacement canister approach. With this approach, the filtration system utilizes canisters that contain the filtration media. When a canister in use becomes spent, it is exchanged for a fresh canister. The media supplier delivers new canisters as needed and disposes of the spent canisters. However, there is still considerable cost with the replacement canister approach as the monthly rental, delivery and disposal costs for a standard sized canister can exceed several thousand dollars.

Thus, both current approaches to media management involve high costs. Both current approaches also require extensive scheduling of filtration media replacement events to coordinate delivery of media and the availability of trained personnel to supervise the replacement. This can lead to significant system downtime if all schedules cannot be coordinated in a reasonable time frame.

Accordingly, it would be desirable to have an integrated filtration and media management system that significantly reduces operation and maintenance costs for overall management of granular media and filter system operations.

### SUMMARY OF THE INVENTION

The above-mentioned need is met by the present invention, which provides an integrated filtration and media management system including a vessel, and a plurality of mesh bags disposed in the vessel. Each one of the mesh bags is filled with a granular filtration media. A hoist is provided for loading and removing bags from the vessel.

The present invention and its advantages over the prior art will become apparent upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a side view of an integrated filtration and media management system.

FIG. 2 is a perspective view of the integrated filtration and media management system of FIG. 1 with the lid in its open position.

FIG. 3 is a top view of the integrated filtration and media management system of FIG. 1 with the lid opened and the mesh bags of filtration media removed.

FIG. 4 is an exploded view of a mesh bag used for containing filtration media.

FIG. 5 is a top view of a mesh bag used for containing filtration media.

FIG. 6 is a side view of the integrated filtration and media management system of FIG. 1 showing a mesh bag of filtration media being loaded.

FIG. 7 is a side view of the integrated filtration and media management system of FIG. 1 showing a mesh bag of filtration media being unloaded.

### DETAILED DESCRIPTION OF THE INVENTION

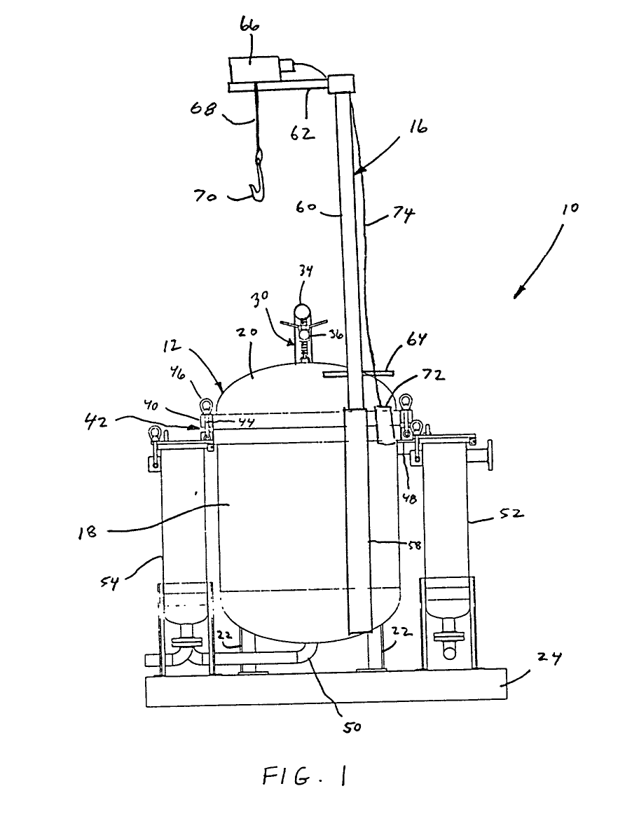

Referring to the drawings wherein identical reference numerals denote the same elements throughout the various views, FIGS. 1-3 show an integrated filtration and media management system 10. The system 10 includes a vessel 12, one or more flexible mesh bags 14 containing granular filtration media, and a hoist 16 for moving the bags 14 in and out of the vessel 12. The flexible bags 14 are designed to be disposed in the interior of the vessel 12 such that a fluid stream flowing through the vessel 12 will pass through the filtration media in the bags 14 and be filtered thereby. The bags 14 can contain any suitable type of filtration media such as activated carbon, activated charcoal, activated alumina, zeolites, ion exchange media and organoclay. The system 10 is suitable for a wide variety of filtration applications including, but not limited to, industrial wastewater treatment, remediation based water treatment, drinking water filtration, offshore oil platform water treatment, gas and vapor filtration, and manufacturing based operations.

In one preferred embodiment, the vessel 12 has a substantially cylindrical configuration and includes a container portion 18 having a lid 20 mounted thereon. The container portion 18 has a cylindrical outer wall and is open at the top and substantially closed at the bottom. A plurality of support legs 22 are provided on the bottom of the container portion 18 for supporting the vessel 12 on a base 24, such as a skid or the like. The lid 20 is a dome-shaped structure that is sized and shaped to fit on the upper rim of the container portion 18 so as to close the interior of the vessel 12 in an liquid-tight manner. The vessel 12 can include “positioners” located on the upper rim of container portion 18 that allow the lid 20 to be properly positioned on the container portion 18.

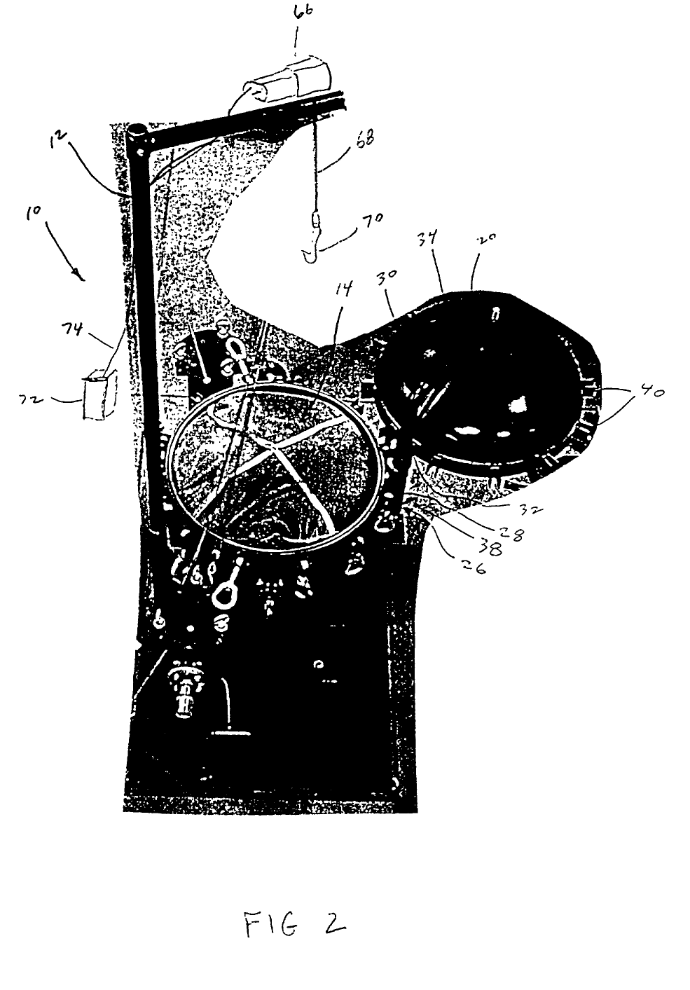

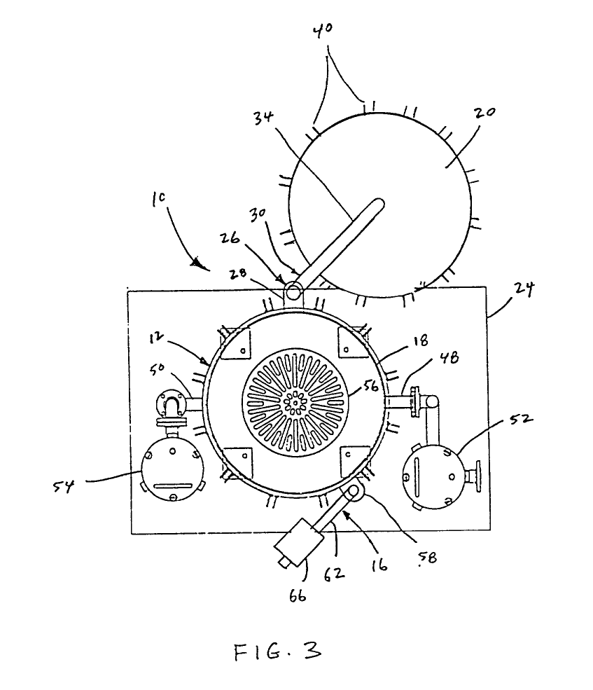

The lid 20 is supported above the container portion 18 by a davit 26 that allows the lid 20 to be easily positioned on, and removed from, the container portion 18. The davit 26 includes a bearing housing 28 fixedly attached to the outer wall of the container portion 18. The bearing housing 28 is an elongated, tube-like structure that is oriented vertically on the container portion 18 with an opening at the top. The davit 26 further includes an L-shaped support arm 30 having a first leg 32 rotationally mounted in the bearing housing 28 and second leg 34 that extends horizontally above the container portion 18. The lid 20 is attached to the distal end of the support arm second leg 34 by a link 36. Because the support arm 30 can be rotated relative to the bearing housing 28, the lid 20 can be swung back and forth between a first position directly over the container portion 18 (FIG. 1) and a second position to the side of the container portion 18 (FIGS. 2 and 3). The davit 26 also includes a hydraulic lift for raising the lid 20 relative to the container portion 18. The bearing housing 28 is partially filled with a hydraulic fluid. A lever 38 is operated to actuate a piston inside bearing housing 28 to pump the hydraulic fluid and raise of lower the support arm 30. Thus, when in the first position, the lid 20 can be lowered onto the upper rim of the container portion 18 to close the interior of the vessel 12. The lid 20 can also be raised off the upper rim when it is desired to move the lid 20 to the second position and provide access to the vessel interior. Alternatively, the lid 20 could be hinged to the upper rim of the container portion 18 to open in a clam shell-type manner.

The vessel 12 is also provided with a means for ensuring an liquid-tight seal between the container portion 18 and the lid 20. In particular, a plurality of U-shaped brackets 40 is attached to the lid 20. The brackets 40 are distributed evenly around the circumference of the lid 20, near its lower edge, and are oriented to extend radially outward. A plurality of quick release clamps 42 is mounted to the outer wall of the container portion 18, adjacent to the upper rim. Each quick release clamp 42 comprises a bolt 44 pivotally attached at one end to the container portion 18. An eye nut 46 or similar fastener is threaded onto the other end of each bolt 44. The quick release clamps 42 are circumferentially spaced about the container portion 18 so that each one is aligned with a corresponding one of the U-shaped brackets 40 when the lid 20 is disposed on top of the container portion 18. The quick release clamps 42 can then be pivoted upward so that each bolt 44 is received within its corresponding bracket 40. The eye nuts 46 are then tightened down to engage the brackets 40 and clamp the lid 20 to the container portion 18. The vessel 12 is preferably, but not necessarily, designed for high pressure (e.g. 150 psi) and high flow rate applications.

The vessel 12 includes an inlet conduit 48 for introducing a fluid stream to be filtered into the vessel 12 and an outlet conduit 50 for discharging the fluid stream therefrom. The inlet conduit 48 extends radially outwardly from the outer wall of the container portion 18, near the upper rim thereof. A pre-filter 52 is coupled to the inlet conduit 48. The pre-filter 52 is provided to remove particulates from the fluid stream prior to passage through the vessel 12. The outlet conduit 50 extends down from the bottom center of the container portion 18 and curves outward to extend radially beyond the container portion 18. A post-filter 54 is coupled to the outlet conduit 50 for removing matter, such as carbon fines, that may have become entrained in the fluid stream as it passed through the vessel 12. The outlet conduit 50 preferably has a tee with a valve inserted therein to allow the vessel 12 to be drained during media replacement operations. The inlet conduit 48 and the outlet conduit 50 are both in fluid communication with the interior of the vessel 12. Thus, a fluid stream entering the top of the vessel 12 via the inlet conduit 48 will pass through the mesh bags 14 and the filtration media contained therein and then exit the vessel 12 via the outlet conduit 50 at the bottom of the vessel 12. As best seen in FIG. 3, an outlet collector 56 is provided inside the container portion 18. The outlet collector 56 is a slotted convex plate located near the bottom of the vessel interior that forces an evenly distributed fluid flow through the filtration media, thereby avoiding media bypass.

As mentioned above, one or more of the flexible mesh bags 14 are disposed in the interior of the vessel 12. The bags 14 are stacked on the outlet collector 56 and generally fill the container portion 18. The stack of bags 14 can also be tailored for maximum filtration performance. That is, instead of each bag 14 in the vessel 12 containing the same type of media, individual bags can be filled with different types of filtration media. This allows for an easy “multimedia” operation where different types of filtration media are employed in a single vessel for a wide range of applications.

The bags 14 are loaded into and removed from the vessel 12 with the hoist 16. The hoist 16 includes a second bearing housing 58 fixedly attached to the outer wall of the container portion 18 at a location generally opposite the first bearing housing 28. The bearing housing 58 is an elongated, tube-like structure that is oriented vertically on the container portion 18 with an opening at the top. An upright support column 60 is rotationally mounted in the bearing housing 58 and extends vertically above the vessel 12. A support beam 62 is attached at one end to the upper end of the support column 60 so as to extend horizontally above the lid 20. A control lever 64 is attached to the support column 60 to enable an operator to rotate the support column 60.

The hoist 16 further includes an electric winch 66 mounted on the distal end of the support beam 62. Thus, by rotating the support column 60, the winch 66 can be moved back and forth between a first position directly over the vessel 12 (FIG. 2) and a second position to the side of the vessel 12. (FIG. 3). The winch 66 has a cable 68 wound thereon, and a hook 70 attached to the end of the cable 68. The winch 66 is situated on the support beam 62 such that when the support column 60 is rotated to position the winch 66 over the vessel 12, the cable 68 and hook 70 can be lowered into the vessel 12. A control pad 72 is connected to the winch 66 via a cord 74 for controlling operation of the winch 66. It should be noted that a manual pulley arrangement could be used as an alternative to the electric winch 66.

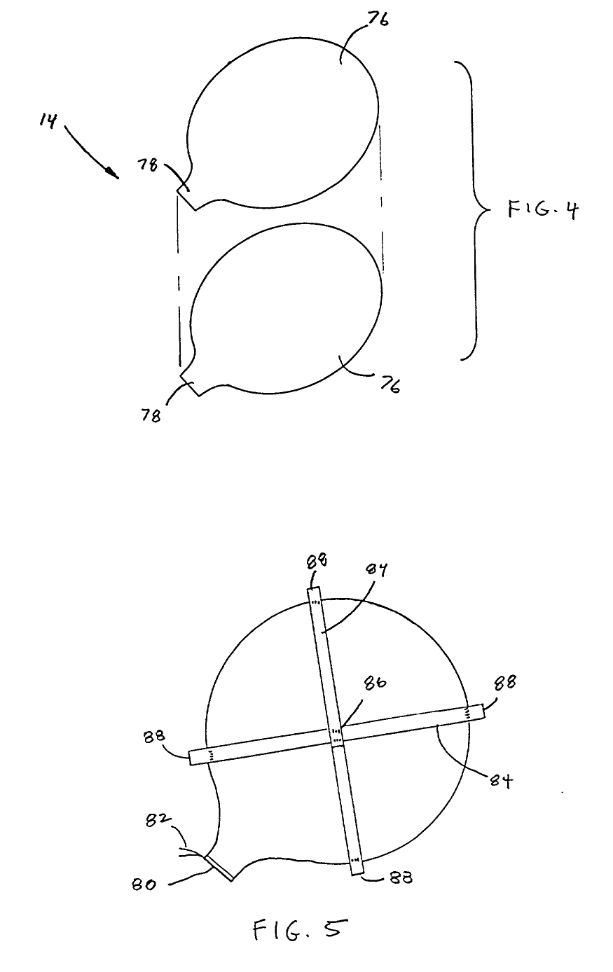

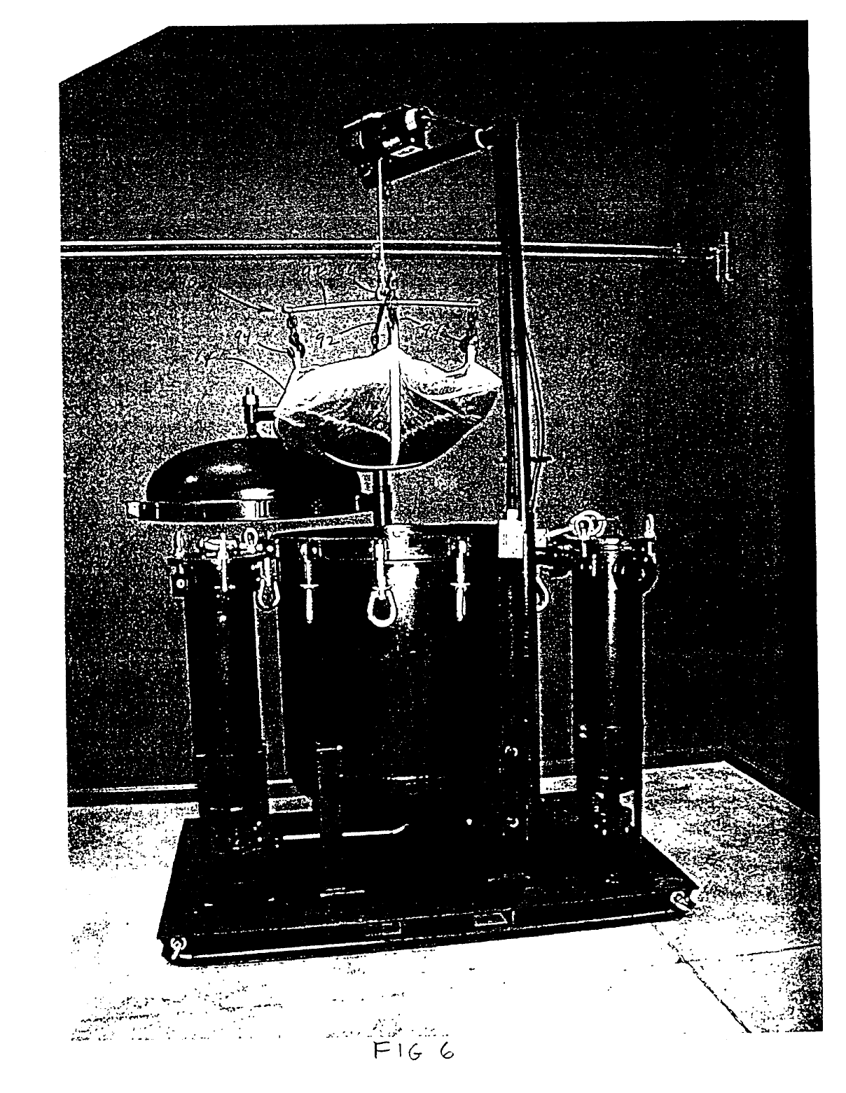

Referring now to FIGS. 4 and 5, it is seen that each bag 14 comprises two identical pieces 76 of mesh material. The pieces 76 are substantially circular in shape with a small flap 78 formed on the perimeter. The bag 14 is assembled by stitching the two pieces 76 together along their outer edges (with the flaps 78 aligned), except for the outermost edge of the flaps 78. This results in a bag interior that is accessible through a side opening 80 that is defined by the flaps 78. The bag 14 can thus be filled with granular filtration media via the opening 80. A drawstring 82 is strung through the stitching around the bag opening 80 to allow the opening 80 to be cinched closed and thereby retain the filtration media in the bag 14. As an alternative to a drawstring, the bag opening could be stitched closed after the bag is filled with filtration media.

Each bag 14 also has a pair of reinforcement straps 84 wrapped therearound. Both straps 84 enclose the exterior of the bag 14 and are mutually perpendicular to one another so as to cross on the bottom and the top of the bag 14. The straps 84 are stitched to the bag 14 along the underside thereof and at the outer edge of the bag 14. The ends of both straps 84 are also stitched together at a center joint 86 where they cross on top of the bag 14. The straps 84 extend slightly beyond the outer edge of the bag 14 at each point so as to define four loops 88, the purpose of which will be described below.

The bag pieces 76 are made of a strong, porous fabric material, such as monofilament nylon, that will allow the fluid being filtered to pass through but retain the granular filtration media. The diameter of the bags 14 depends on the inside diameter of the vessel 12. Preferably, the bag diameter is slightly greater than the vessel inside diameter. For instance, 36-inch diameter bags would be used with a 30-inch diameter vessel. The flexible nature of the bags 14 will allow them to conform to the smaller vessel diameter and assure that the entire cross-section of the vessel 12 is provided with filtration media. The amount of filtration media fed into each bag 14 will vary for a given application. Generally, the amount of filtration media will be determined by how well it can be distributed. Too much media for a given size bag will result in a cumbersome bag that is difficult to obtain good media distribution within. Too little media in a bag will result in an uneconomical system because a large number of bags will need to be used. In one possible embodiment, each bag 14 contains one cubic foot of carbon filtration media and weighs about 30-55 pounds. The vessel 12 could be sized to accommodate up to 15 such bags.

The discrete bags of filtration media can be shipped to filtration system operators in storage containers such as standard 55-gallon drums or lined fiberpak drums. This greatly simplifies on site storage and management of the filtration media for the operator. The storage containers also allow for outdoor storage and minimize the potential for media spoilage or contamination. The storage containers can also be reused as disposal receptacles for spent bags removed from the filtration vessel 12, thereby minimizing disposal management requirements. This approach allows for streamlined management of spent media as the media is properly packaged for storage, transportation and disposal.

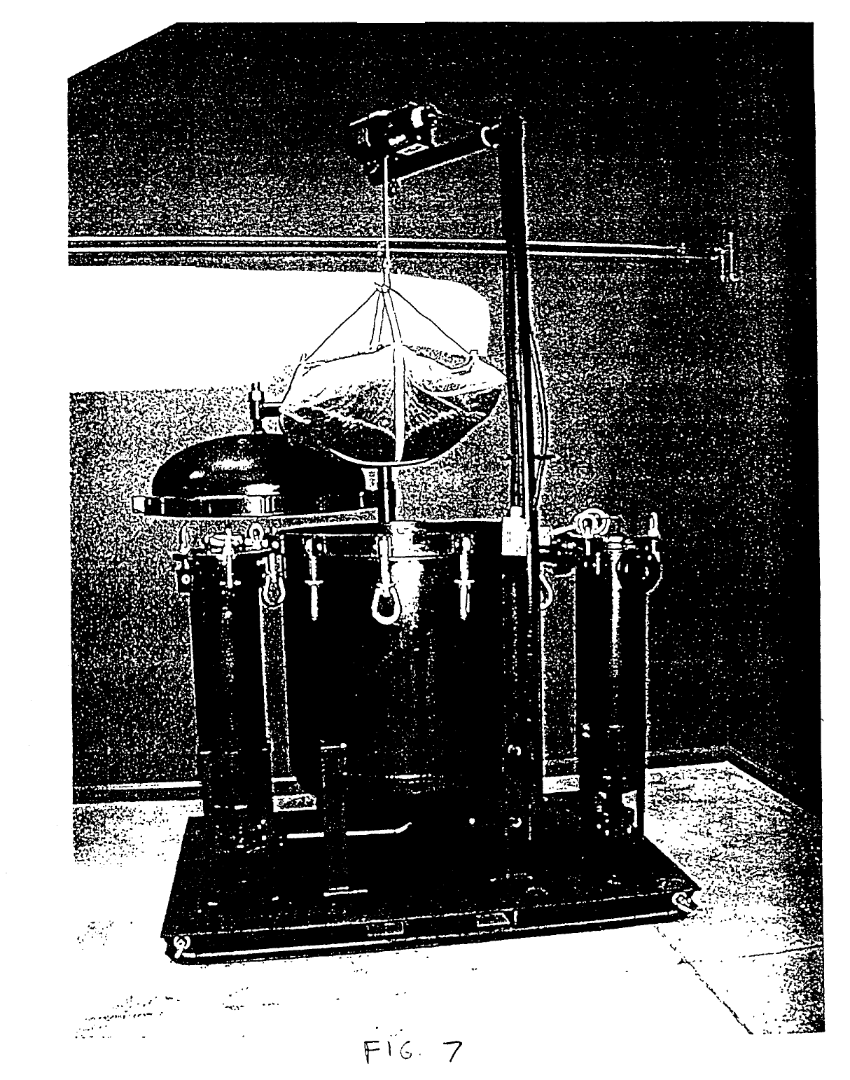

In operation, the desired number of bags 14 for a given application is loaded into the vessel 12 with the hoist 16. The loading operation is shown in FIG. 6. The bag 14 to be loaded into the vessel 12 is attached to the cable 68. Although the bag 14 could be coupled directly to the cable 68 by hooking the hook 70 to the strap center joint 86, it is preferably coupled using a multi-point pick 90, as shown in FIG. 6. The multi-point pick 90 comprises two mutually perpendicular rods 92 of equal length that are joined together, such as by welding, at their respective midpoints. The rods 92 thus define four outwardly extending arms. A hook 94 is attached to the outer end of each of these arms, and a ring 96 is joined to the center joint of the rods 92.

The bag 14 is coupled to the cable 68 by hooking each hook 94 to a corresponding one of the strap loops 88. The cable hook 70 is then hooked to the ring 96 to complete the connection. Use of the multi-point pick 90 provides a more even distribution of the filtration media in the bags 14, thereby facilitating the loading process. The multi-point pick 90 also distributes the load so as to minimize bag tearing. With the bag 14 so coupled, the winch 66 is operated (through the control pad 72) to wind the cable 68 and raise the bag 14 to a sufficient height above the upper rim of the container portion 18. With the lid 20 in its open position, an operator rotates the support column 60 via the control lever 64 so that the bag 14 is suspended directly over the open vessel 12. The operator then operates the winch 66 to unwind the cable 68 and lower the bag 14 into the container portion 18. The hooks 94 are unhooked, and the winch 66 is operated to wind the cable 68 again and raise the multi-point pick 90 out of the container portion 18.

Subsequent bags 14 are loaded in the same manner. When all of the bags 14 are loaded, the lid 20 is swung into position over the container portion 18 and lowered onto the upper rim thereof. Prior to closing the lid 20, a retainer ring (not shown) can optionally be placed over the stack of mesh bags 14 to hold them securely in place during filtration operations. The quick release clamps 42 are then clamped to the U-shaped brackets 40 to seal the lid 20 onto the container portion 18. At this point the system 10 is ready for filtration operation. During filtration operation, the pressure drop across the bags of filtration media will be slightly higher than the pressure drop across a similarly sized bed of bulk filtration media. However, the system 10 is designed for applications where high pressure pumps are normally employed, and the anticipated working pressures of 30-60 psi are in the operable range of most treatment or remediation systems. It is estimated that the pressure drop in a system employing ten bags containing approximately 2.5 cubic feet of filtration media will be less than 2 psi.

Over time, the filtration media in the bags 14 will become saturated and unable to adsorb further impurities. At this point, the spent bags are replaced with fresh bags. This is accomplished by disengaging the quick release clamps 42, raising the lid 20, and swinging it to the open position away from the container portion 18. Next, the hoist 16 is positioned with the winch 66 over the open vessel 12, and the cable 68 is lowered so that the cable hook 70 can be hooked to the strap center joint 86. The winch 66 is then operated (through the control pad 72) to wind the cable 68 and raise the spent bag 14 to a sufficient height above the upper rim of the container portion 18, as shown in FIG. 7. The multi-point pick 90 is not used in bag removal because uniform distribution of the media is not as big an issue during removal, and using a single connection (instead of four with the multi-point pick 90) reduces that amount of potential operator contact with the contaminated media and improves media changeover time. The hoist 16 is rotated to position the spent bag 14 over a storage container, and the winch 66 is operated to lower the bag 14 into the storage container. Once all of the spent bags are so removed, the fresh bags are loaded into the vessel in the manner described above.

The foregoing has described a unique design of a vessel, filtration media bags and shipping/disposal system that creates a fully integrated system for filtration operations and management of filtration media. One feature of the system is the ease in which filtration media can be quickly removed and loaded by a single individual without specialized equipment. This reduces system downtime, eliminates the need for coordination activities with additional manpower or subcontractors, and reduces reliance on filtration media suppliers. Additionally, the filtration media bags are shipped to system operators in storage containers to allow for on site storage of new and spent filtration media bags and the subsequent transportation and disposal of spent bags for a completely integrated process. The system significantly reduces operation and maintenance costs as compared to conventional filtration systems.

While specific embodiments of the present invention have been described, it will be apparent to those skilled in the art that various modifications thereto can be made without departing from the spirit and scope of the invention as defined in the appended claims.

What is claimed is:

1. An integrated filtration and media management system comprising:
a vessel;
at least one mesh bag disposed in said vessel, said mesh bag being filled with a filtration media; and
a hoist positioned for loading and removing mesh bags from said vessel.

2. The integrated filtration and media management system of claim 1 wherein said hoist comprises:
a bearing housing fixedly attached to a side of said vessel;
a support member rotationally mounted in said bearing housing; and
a winch mounted on said support member, wherein said support member can be rotated to selectively position said winch over said vessel.

3. The integrated filtration and media management system of claim 2 wherein said support member includes a support column rotationally mounted in said bearing housing and extending vertically above said vessel and a support beam attached at a first end to said support column so as to extend horizontally above said vessel, said winch being mounted to said support beam.

4. The integrated filtration and media management system of claim 2 wherein said winch includes a cable and a hook attached to an end of said cable.

5. The integrated filtration and media management system of claim 4 further comprising a multi-point pick having a plurality of outwardly extending arms and a hook connected to each one of said arms, said multi-point pick being hooked to said hook attached to said cable.

6. The integrated filtration and media management system of claim 1 wherein said mesh bag is made of a strong, porous fabric material.

7. The integrated filtration and media management system of claim 1 wherein said mesh bag is substantially circular and has a side opening.

8. The integrated filtration and media management system of claim 7 wherein said vessel defines an inside diameter and said mesh bag has a diameter that is greater than said inside diameter.

9. The integrated filtration and media management system of claim 1 further comprising a pair of reinforcement straps wrapped around said mesh bag, wherein said straps are mutually perpendicular to one another so as to cross on opposite sides of said mesh bag and define a plurality of loops.

10. An integrated filtration and media management system comprising:
a vessel having an inlet conduit and an outlet conduit, said vessel further including a container portion and a lid mounted to said container portion by a davit that allows said lid to be easily positioned on, and removed from, said container portion;
a plurality of mesh bags disposed in said container portion, each one of said mesh bags being filled with a filtration media; and
a hoist positioned for loading and removing said mesh bags from said vessel.

11. The integrated filtration and media management system of claim 10 wherein said hoist comprises:
a bearing housing fixedly attached to a side of said container portion;
a support member rotationally mounted in said bearing housing; and
a winch mounted on said support member, wherein said support member can be rotated to selectively position said winch over said vessel.

12. The integrated filtration and media management system of claim 11 wherein said support member includes a support column rotationally mounted in said bearing housing and extending vertically above said lid and a support beam attached at a first end to said support column so as to extend horizontally above said lid, said winch being mounted to said support beam.

13. The integrated filtration and media management system of claim 11 wherein said winch includes a cable and a hook attached to an end of said cable.

14. The integrated filtration and media management system of claim 13 further comprising a multi-point pick having a plurality of outwardly extending arms and a hook connected to each one of said arms, said multi-point pick being hooked to said hook attached to said cable.

15. The integrated filtration and media management system of claim 10 wherein each mesh bag is made of a strong, porous fabric material.

16. The integrated filtration and media management system of claim 10 wherein each mesh bag is substantially circular and has a side opening.

17. The integrated filtration and media management system of claim 16 wherein said container portion defines an inside diameter and each mesh bag has a diameter that is greater than said inside diameter.

18. The integrated filtration and media management system of claim 10 further comprising a pair of reinforcement straps wrapped around each mesh bag, wherein said straps of each pair are mutually perpendicular to one another so as to cross on opposite sides of said mesh bag and define a plurality of loops.

19. The integrated filtration and media management system of claim 10 wherein individual ones of said plurality of mesh bags are filled with different types of filtration media.
